(19) United States
(12) Patent Application Publication
(10) Pub. No.: US 2012/0039455 A1
(43) Pub. Date: Feb. 16, 2012

(54) Phone Domain Name Service

(76) Inventors: Yeonchul Kim, Lynnwood, WA (US); Tony H. Kim, Lynnwood, WA (US)

(21) Appl. No.: 13/013,123

(22) Filed: Jan. 25, 2011

Related U.S. Application Data
(63) Continuation-in-part of application No. 12/492,634, filed on Jun. 26, 2009.
Application No. 12/492,634 is a continuation-in-part of application No. 12/465,095, filed on May 13, 2009.
(60) Provisional application No. 61/218,340, filed on Jun. 18, 2009.
(60) Provisional application No. 61/167,031, filed on Apr. 6, 2009.

(51) Int. Cl. H04M 3/42

(52) U.S. Cl. 379/201.01

(57) ABSTRACT

This invention relates generally to communications, and more specifically, to systems and methods for providing a phone domain name service. In one embodiment, the invention includes a phone domain name service configured to performing the operations including receiving a phone address, the phone address comprising a phone name associated with a phone domain name; receiving a location, the location comprising a latitudinal coordinate and a longitudinal coordinate; accessing a database for the phone domain name, the database for the phone domain name comprising one or more phone names and locations corresponding to one or more phone numbers; and retrieving a phone number corresponding to the phone name or location from the database for the phone domain name.

### PRIORITY CLAIM

This application is a continuation-in-part of U.S. application Ser. No. 12/492,634 filed Jun. 26, 2009 (our ref. YKIM-1-1002-1), which application claims the benefit of U.S. application Ser. No. 61/218,340 filed Jun. 18, 2009 (our ref. YKIM-1-1002); is a continuation-in-part of U.S. application serial number UNKNOWN entitled Phone Name Service filed contemporaneously herewith (our ref. YKIM-1-1001-1); and is a continuation-in-part of U.S. application Ser. No. 12/465,095 filed May 13, 2009 (our ref. YKIM-1-1001-1), which application claims the benefit of U.S. application Ser. No. 61/167,031 filed Apr. 6, 2009 (our ref. YKIM-1-1001). Applicant claims the benefit of/priority to each of the foregoing applications and any parent, grandparent, and/or child applications of the foregoing applications. The foregoing applications are incorporated by reference in their entirety as if fully set forth herein.

### FIELD OF THE INVENTION

This invention relates generally to communications, and more specifically, to systems and methods for providing a phone domain name service.

### SUMMARY

This invention relates generally to communications, and more specifically, to systems and methods for providing a phone domain name service. In one embodiment, the invention includes a phone domain name service configured to performing the operations including receiving a phone address, the phone address comprising a phone name associated with a phone domain name; receiving a location, the location comprising a latitudinal coordinate and a longitudinal coordinate; accessing a database for the phone domain name, the database for the phone domain name comprising one or more phone names and locations corresponding to one or more phone numbers; and retrieving a phone number corresponding to the phone name or location from the database for the phone domain name.

### BRIEF DESCRIPTION OF THE DRAWINGS

Embodiments of the present invention are described in detail below with reference to the following drawings:

FIG. 1 is a system diagram for implementing a phone domain name service, in accordance with an embodiment of the invention;

FIG. 2 is a flow diagram of a method performed by a software application of a phone domain name service, in accordance with an embodiment of the invention; and

FIGS. 3-10 are flow diagrams including various embodiments of a method performed by a software application of a phone domain name service, in accordance with various embodiments of the invention.

### DETAILED DESCRIPTION

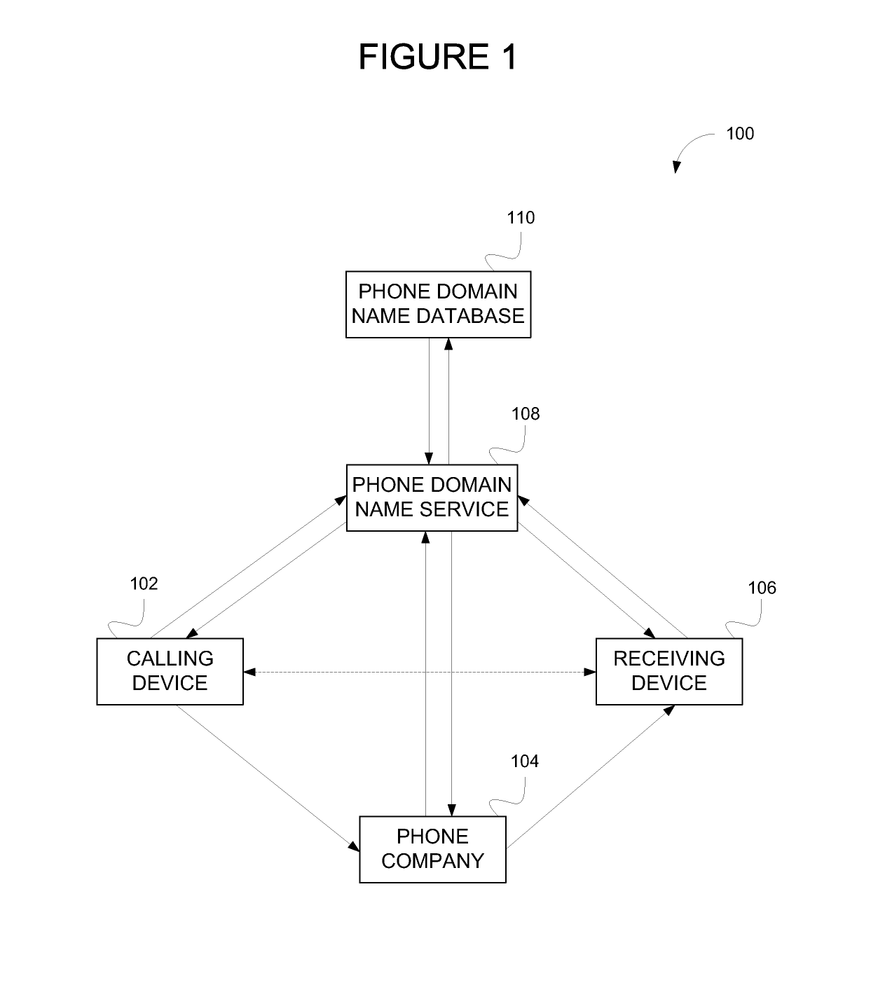

This invention relates generally to communications, and more specifically, to systems and methods for providing a phone domain name service. Specific details of certain embodiments of the invention are set forth in the following description and in FIGS. 1-10 and Appendix A to provide a thorough understanding of such embodiments. The present invention may have additional embodiments, may be practiced without one or more of the details described for any particular described embodiment, or may have any detail described for one particular embodiment practiced with any other detail described for another embodiment.

FIG. 1 is a system diagram for implementing a phone domain name service, in accordance with an embodiment of the invention. In some embodiments, system 100 includes a calling device 102, a phone company 104, a receiving device 106, a phone domain name service 108, and a phone domain name database 110. The calling device 102 is any device usable to establish communication with the receiving device 106. For example, the calling device 102 can include a telephone, a mobile phone, a personal digital assistant, an internet appliance, a computer, or some other similar device. Likewise, the receiving device 106 is any device usable to receive communication from the calling device 102. For example, the receiving device 106 can include a telephone, a mobile phone, a personal digital assistant, an internet appliance, a computer, or some other similar device. The phone company 104 is any entity usable to facilitate communications between the calling device 102 and the receiving device 106. For example, the phone company 104 can include AT&T, VERIZON, SPRINT, COMCAST, or some other similar entity. The phone domain name database 110 is any software or hardware configurable to store data, such as a relational database like SQL or ORACLE. The phone domain name service 108 is a computer hardware implemented software application configured to implement various embodiments disclosed herein that is communicatably accessible to or with any of the calling device 102, the phone company 104, the receiving device 106, and the phone domain name database 110. In some embodiments, the calling device 102, the phone company 104, the receiving device 106, the phone domain name service 108, or the phone domain name database 110 can be combined into fewer components or distributed to additional components. In some embodiments, any form of communication can be employed between the calling device 102, the phone company 104, the receiving device 106, the phone domain name service 108, and the phone domain name database 110, such as analogue, digital, electronic, wireless, or satellite communication.

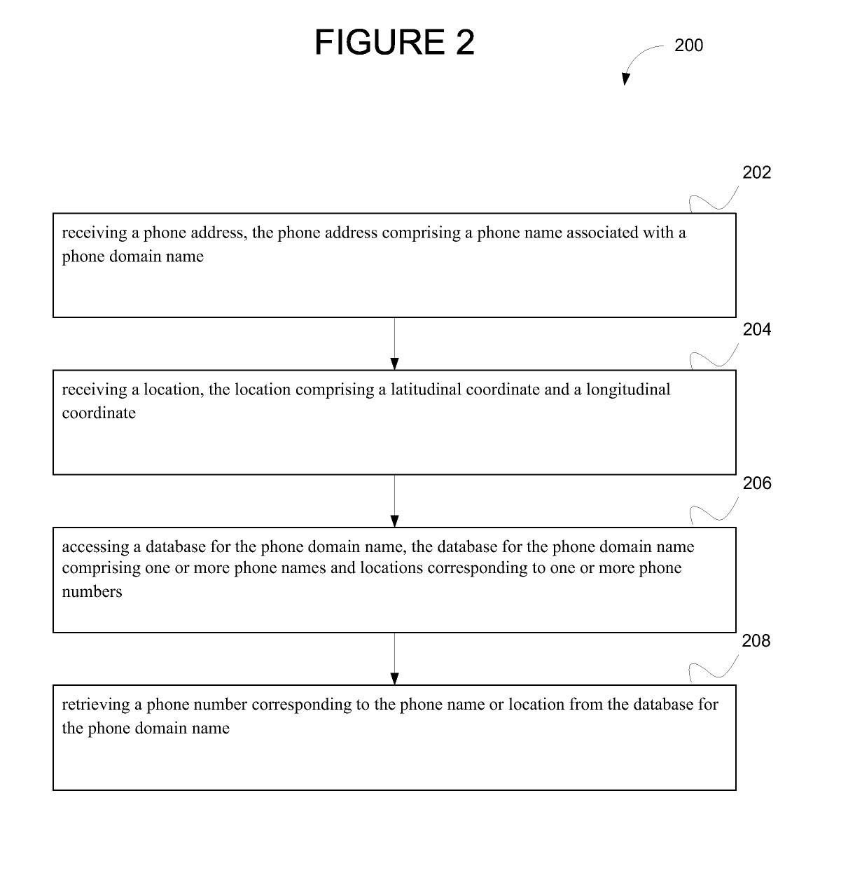

FIG. 2 is a flow diagram of a method performed by a software application of a phone domain name service, in accordance with an embodiment of the invention. In some embodiments, method 200 is performed by a software application of the phone domain name service 108. Method 200 includes receiving a phone address, the phone address comprising a phone name associated with a phone domain name; receiving a location, the location comprising a latitudinal coordinate and a longitudinal coordinate; accessing a database for the phone domain name, the database for the phone domain name comprising one or more phone names and locations corresponding to one or more phone numbers; and retrieving a phone number corresponding to the phone name or location from the database for the phone domain name. For example, the receiving a phone address may include receiving MOUNTAINVIEW [symbol] GOOGLE.COM, wherein the phone name is MOUNTAINVIEW and the phone domain name is GOOGLE.COM. The accessing a database for the phone domain name may include accessing the database for the GOOGLE.COM phone domain name, wherein the database may include the following combinations of phone names, locations, and phone numbers:

TABLE 1
GOOGLE.COM PHONE DOMAIN NAME DATABASE

| | LOCATION | | |
|---|---|---|---|
| PHONE NAME | LATITUDE | LONGITUDE | PHONE |
| MOUNTAINVIEW | 37.422799 | −122.085003 | 650-253-0000 |
| SEATTLE | 47.648732 | −122.350608 | 206-876-1500 |
| BEIJING | 39.983500 | 116.333413 | 86-10-62503000 |
| HONG KONG | | | 852-3923-5400 |
| MUMBAI | | | 91-22-6611-7200 |
| SEOUL | | | 82-2-531-9000 |
| PARIS | | | 33-01-42-68-53-00 |
| AMSTERDAM | | | 31-020-5045-100 |
| MOSCOW | | | 7-495-644-1400 |
| MADRID | | | 34-91-748-6400 |
| LONDON | | | 44-020-7031-3000 |
| MONTREAL | | | 514-670-8700 |
| DUBAI | | | 971-4-4370-680 |

The retrieving a phone number corresponding to the phone name or location from the database for the phone domain name may include retrieving the 650-253-0000 phone number corresponding to the MOUNTAINVIEW phone name from the database for the GOOGLE.COM phone domain name.

Alternatively, the receiving a phone address may include receiving PARIS [symbol] GOOGLE.COM, wherein the phone name is PARIS and the phone domain name is GOOGLE.COM. The accessing a database for the phone domain name may include accessing the database for the GOOGLE.COM phone domain name, wherein the database may include the combinations of phone names, locations, and phone numbers set forth in TABLE 1. The retrieving a phone number corresponding to the phone name or location from the database for the phone domain name may include retrieving the 33-01-42-68-53-00 phone number corresponding to the PARIS phone name from the database for the GOOGLE.COM phone domain name.

Alternatively, the receiving a phone address may include receiving NEARESTLOC [symbol] GOOGLE.COM, wherein the phone name is NEARESTLOC and the phone domain name is GOOGLE.COM. The receiving a location may include receiving (37.422799,−122.085003), wherein the latitudinal coordinate is 37.422799 and the longitudinal coordinate is −122.085003. The accessing a database for the phone domain name may include accessing the database for the GOOGLE.COM phone domain name, wherein the database may include the combinations of phone names, locations, and phone numbers set forth in TABLE 1. The retrieving a phone number corresponding to the phone name or location from the database for the phone domain name may include retrieving the 650-253-0000 phone number corresponding to the (37.422799,−122.085003) location, or corresponding to a range of locations including the (37.422799,−122.085003) location, from the database for the GOOGLE.COM phone domain name.

Thus, the receiving a phone address may include receiving any phone name associated with any phone domain name. For example, phone names may include personal names, business names, coined words, arbitrary words, geographic locations, numbers, or any other alphanumeric character or characters. Similarly, phone domain names may include personal names, business names, coined words, arbitrary words, geographic locations, number, or any other alphanumeric character or characters. In some embodiments, phone domain names coincide with internet domain names such as GOOGLE.COM, MICROSOFT.COM, WHITEHOUSE.GOV, or WASHINGTON.EDU. However, phone domain names may not coincide with internet domain names or phone domain names may have different extensions such as .PHN or .CALL or .DIAL. Further, the accessing a database for the phone domain name may include accessing a database having data for a plurality of phone domain names or accessing a database having data for a single phone domain name. The database for the phone domain name may include phone names and phone numbers related to family, friends, business, education, or the like. Accordingly, the retrieving a phone number corresponding to a phone name or location from a database for a phone domain name may include retrieving John Wilson's mobile telephone number for the phone address of JOHN [symbol] WILSONFAMILY.PHN or retrieving Seattle Roofing Company's reception phone number for the phone address of RECEPTION [symbol] SEATTLEROOFING.PHN.

The receiving a location may include receiving any worldwide location represented by latitudinal and longitudinal coordinates. Further, the database for the phone domain may include one or more locations including a latitudinal and longitudinal coordinate for each. Accordingly, the retrieving a phone number corresponding to a phone name or location from a database for a phone domain may include retrieving the phone number 650-253-0000 corresponding to Google's Mountain View location at location (37.422799,−122.085003).

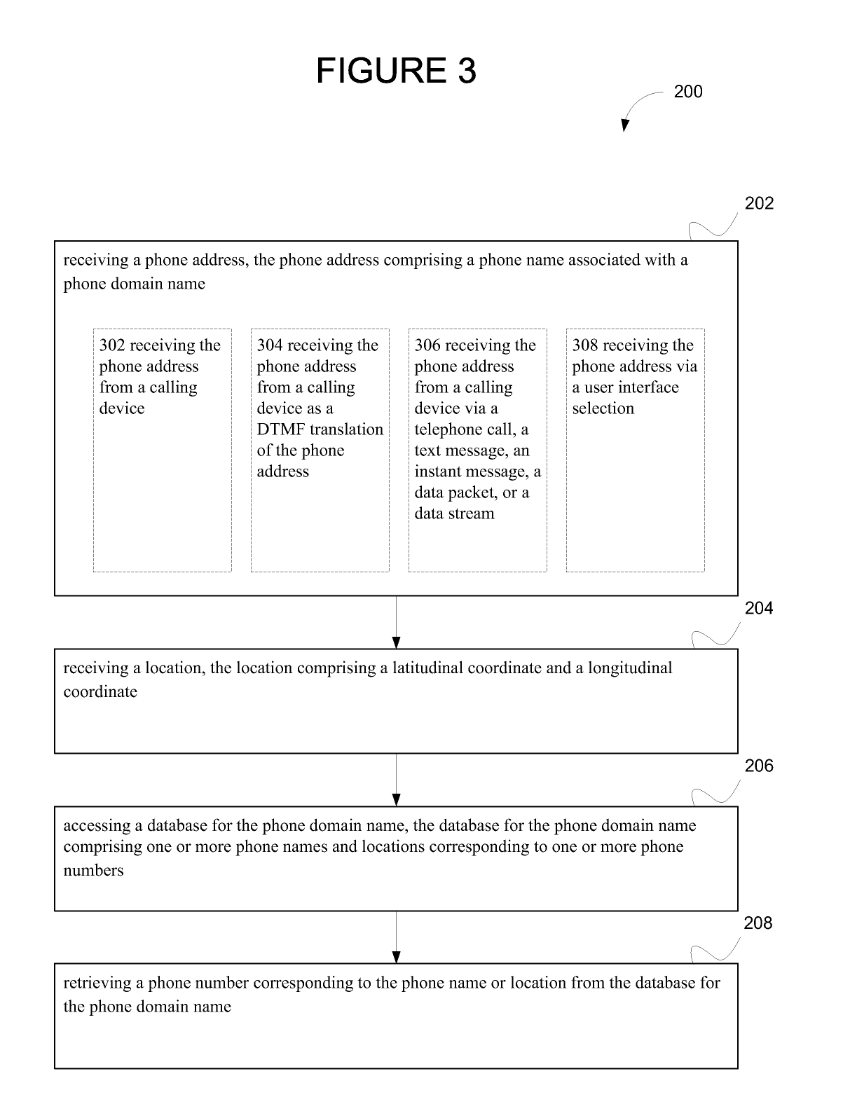

FIG. 3 is a flow diagram including various embodiments of a method performed by a software application of a phone domain name service, in accordance with various embodiments of the invention. Method 200 may include one or more operations including operations 302, 304, 306, and/or 308.

At operation 302, the receiving a phone address at 202 may include receiving the phone address from a calling device. In some embodiments, the phone domain name service 108 receives the phone address from the calling device 102. For example, the calling device 102 may receive the phone address via user input or user selection and may communicate the phone address to the phone domain name service 108 using electronic or wireless communication. The phone address may be received through a physical or electronic keyboard, spoken letters or words, an email or text message signature, a contact database, a website, barcode scanning or character recognition, or through some other similar means. The phone address may be communicated to the phone domain name service 108 using data packets, streaming data, tone frequencies, or some other similar methodology. Alternatively, the calling device 102 may provide the phone address to the phone domain name service 108 via a user interface such as an internet website, client application, structured voice interaction menu system, or the like.

At operation 304, the receiving a phone address at 202 may include receiving the phone address from a calling device as a DTMF translation of the phone address. In some embodiments, the phone domain name service 108 receives the phone address from the calling device 102 as a DTMF translation of the phone address. For example, the calling device 102 may translate an alphanumeric phone address into a DTMF set of numbers and/or characters that are communicated to the phone domain name service 108 using telephone communication. The phone domain name service 108 receives and uses the DTMF translation to retrieve a phone 170 number. For example, the following table can be used for providing a DTMF translation; although it should be clear that alternate methodologies can be employed and that DTMF translations are not required.

TABLE 2
DTMF TRANSLATION OF PHONE ADDRESS

| | Char | | | | | | | | | |
|---|---|---|---|---|---|---|---|---|---|---|
| | 1 | 2 | A | B | C | 3 | D | E | F | 4 |
| DTMF | 1 | 2 | 22 | 222 | 2222 | 3 | 33 | 333 | 3333 | 4 |

| | Char | | | | | | | | | |
|---|---|---|---|---|---|---|---|---|---|---|
| | G | H | I | 5 | J | K | L | 6 | M | N |
| DTMF | 44 | 444 | 4444 | 5 | 55 | 555 | 5555 | 6 | 66 | 666 |

| | Char | | | | | | | | | |
|---|---|---|---|---|---|---|---|---|---|---|
| | O | 7 | P | Q | R | S | 8 | T | U | V |
| DTMF | 6666 | 7 | 77 | 777 | 7777 | 77777 | 8 | 88 | 888 | 8888 |

| | Char | | | | | | | |
|---|---|---|---|---|---|---|---|---|
| | 9 | W | X | Y | Z | * | 0 | # |
| DTMF | 9 | 99 | 999 | 9999 | 99999 | * | 0 | # |

At operation 306, the receiving a phone address at 202 may include receiving the phone address from a calling device via a telephone call, a text message, an instant message, a data packet, or a data stream. In some embodiments, the phone domain name service 108 receives the phone address from the calling device 102 via a telephone call, a text message, an instant message, a data packet, or a data stream. For example, the phone domain name service 108 may receive the phone address from the calling device 102 upon the calling device 102 initiating a phone call using the phone address, such as dialing BILL [symbol] JOHNLSCOTT.CALL or JIM [symbol] RUTTLERLAW.DIAL. In certain embodiments, the calling device 102 may include a software application to differentiate between a phone address and a telephone number and to initiate phone calls to the phone domain name service 108 for any phone addresses. Alternatively, the phone domain name service 108 may receive the phone address from the calling device 102 through interaction of the calling device 102 with a structured voice interaction system of the phone domain name service 108. Differently, the phone domain name service 108 may receive the phone address from the calling device 102 upon the calling device 102 communicating a text message including the phone address or upon the calling device 102 communicating a data packet or streaming data including the phone address. For example, the calling device 102 may communicate the phone address, such as SUPPORT [symbol] VERIZONWIRELESS.COM or ROOFING-SEATTLE [symbol] HOMEDEPOT.COM, as the phone address is input, upon entering the phone address, or upon user request. In certain embodiments, the calling device 102 may include a software application to facilitate communicating a text message, instant message, data packet, or streaming data to the phone domain name service 108.

At operation 308, the receiving a phone address at 202 may include receiving the phone address via a user interface selection. In some embodiments, the phone domain name service 108 receives the phone address via user interface selection. The user interface may include a customer service representative, a structured voice interaction system, a website, a client software application, a server software application, or another similar user interface. For example, the phone domain name service 108 may receive the phone address, such as TICKETS [symbol] SEATTLEMARINERS.PHN, via user interface selection on a mobile phone software application. Alternatively, the phone domain name service 108 may receive the phone address, such as HOME [symbol] JONESFAMILYNY.COM, via user interface selection on an internet website. In certain embodiments, the user interface may facilitate categorical, geographic, alphabetical, or subject matter searching and/or browsing of phone addresses. In other embodiments, the user interface may facilitate storage and/or communication of phone addresses to specified destinations.

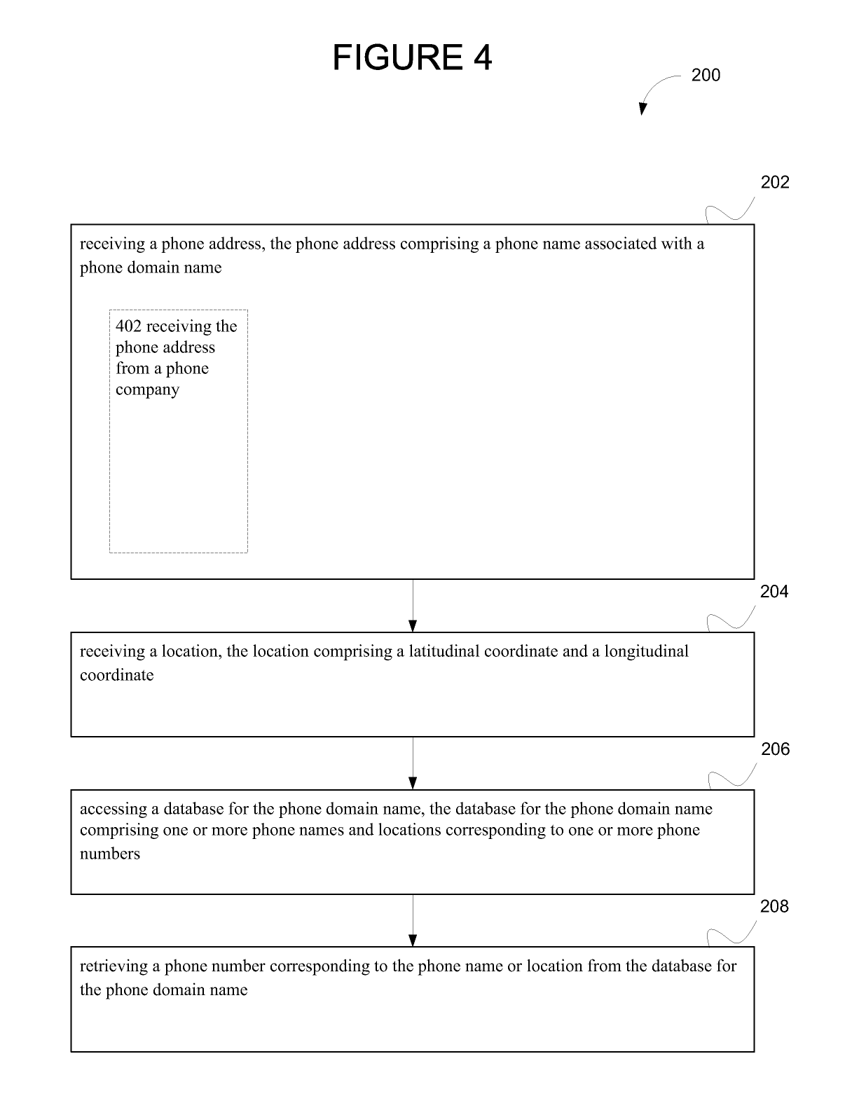

FIG. 4 is a flow diagram including various embodiments of a method performed by a software application of a phone domain name service, in accordance with various embodiments of the invention. Method 200 may include one or more operations including operation 402.

At operation 402, the receiving a phone address at 202 may include receiving the phone address from a phone company. In some embodiments, the phone domain name service 108 receives the phone address from the phone company 104. In some embodiments, the phone domain name service 108 may receive the phone address from the phone company 104 as a DTMF translation. In some embodiments, the phone company 104 may receive the phone address from the calling device 102. In some embodiments, the phone company 104 may receive the phone address from the calling device 102 as a DTMF translation of the phone address. In some embodiments, the phone company 104 may receive the phone address from the calling device 102 via a telephone call, a text message, an instant message, a data packet, or a data stream. In some embodiments, the phone company 104 may receive the phone address via user interface selection. For example, the calling device 102 may translate a phone address into a DTMF set of numbers and/or characters and communicate the DTMF translation to the phone company 104 using telephone communication. The phone company 104 may then forward the DTMF translation to the phone domain name service 108 to retrieve a phone number.

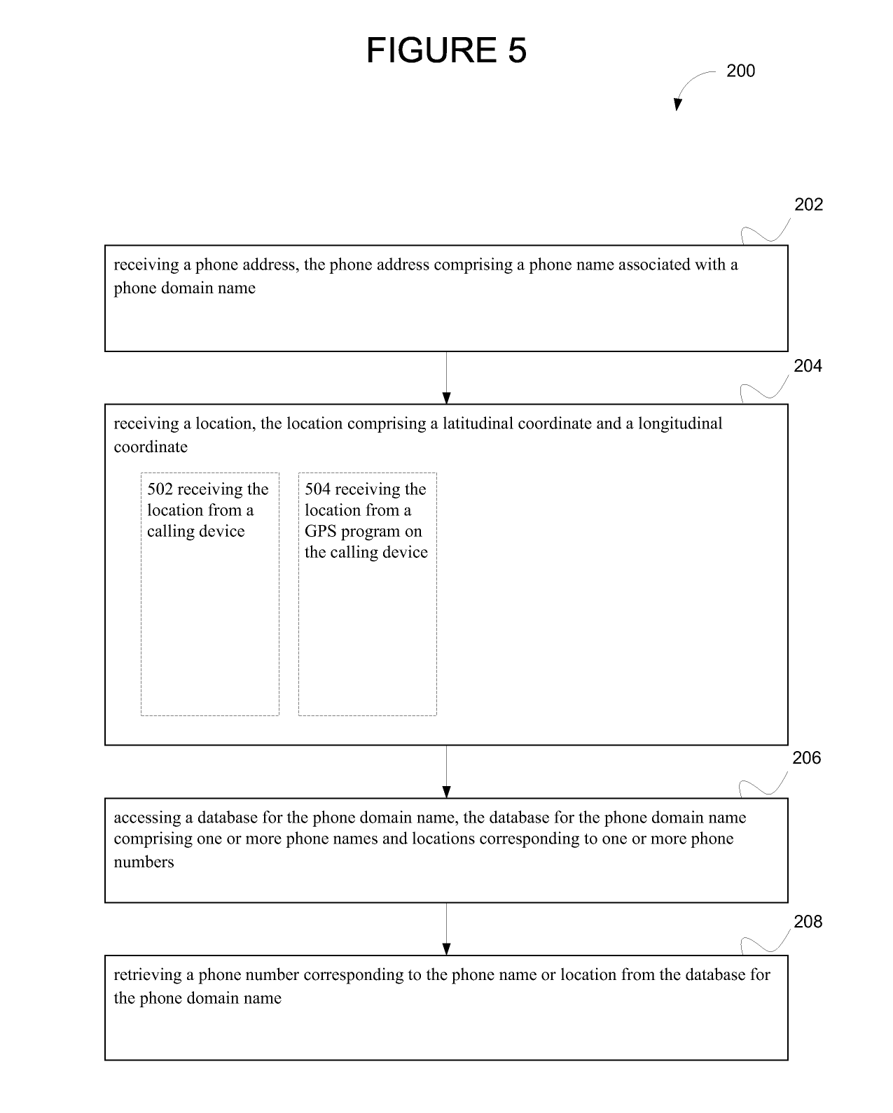

FIG. 5 is a flow diagram including various embodiments of a method performed by a software application of a phone domain service, in accordance with various embodiments of the invention. Method 200 may include one or more operations including operation 502 or 504.

At operation 502, the receiving a location at 204 may include receiving the location from a calling device. In some embodiments, the phone domain name service 108 receives the location from the calling device 102. For example, the calling device 102 may receive the location via user input or user selection and may communicate the location to the phone domain name service 108 using electronic or wireless communication. The location may be received through a physical or electronic keyboard, spoken letters or words, an email or text message signature, a contact database, a website, barcode scanning or character recognition, or through some other similar means. The location may be communicated to the phone domain name service 108 using data packets, streaming data, tone frequencies, or some other similar methodology. Alternatively, the calling device 102 may provide the location to the phone domain name service 108 via a user interface such as an internet website, client application, structured voice interaction menu system, or the like.

At operation 504, the receiving a location at 204 may include receiving the location from a GPS program on the calling device. In some embodiments, the phone domain name service 108 receives the location from the calling device 102 via a GPS program on the calling device. For example, the phone domain name service 108 may receive the location from the calling device 102 upon the calling device 102 initiating a phone call using the phone address, such as dialing NEARESTLOC [symbol] GOOGLE.COM. In certain embodiments, the calling device 102 may include a software application to select between request for a telephone number using a phone name and a location, and to send GPS coordinates to the phone domain name service 108 for any requests including a location.

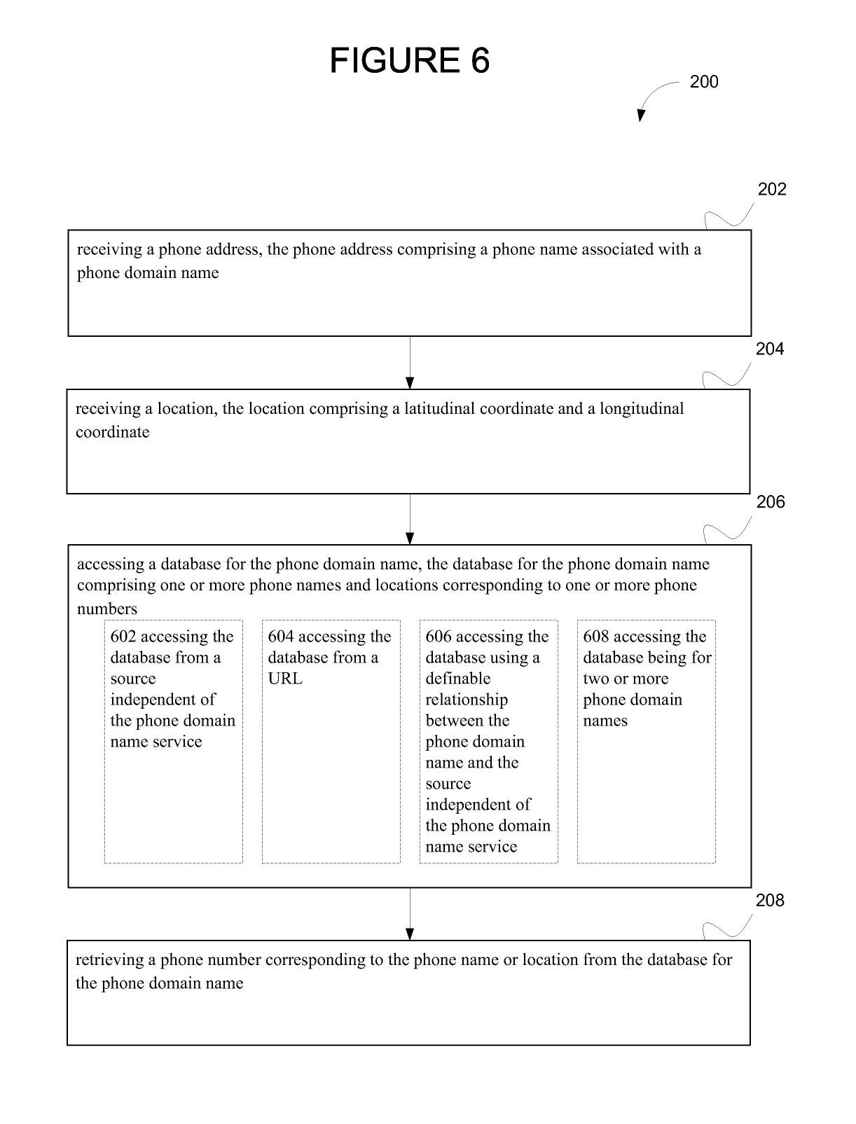

FIG. 6 is a flow diagram including various embodiments of a method performed by a software application of a phone domain name service, in accordance with various embodiments of the invention. Method 200 may include one or more operations including operation 602, 604, 606, and/or 608.

At operation 602, the accessing a database for the phone domain name at 206 may include accessing the database from a source independent of the phone domain name service. In some embodiments, the phone domain name service 108 accesses the database 110 from a source independent of the phone domain name service 108. The phone domain name service 108 may access the database 110 from a third party computer system, a local area network location, a wide area network location, an internet location, an internet web server, an internet FTP server, or at some other similar location. For example, the phone domain name service 108 may access the database 110 for the MICROSOFT.PHN phone domain name from a server controlled by MICROSOFT CORPORATION. Similarly, the phone domain name service 108 may access the database 110 for the GONZALESFAMILYNM.COM phone domain name from a third party internet hosting website.

At operation 604, the accessing a database for the phone domain name at 206 may include accessing the database from a URL. In some embodiments, the phone domain name service 108 accesses the database 110 from a URL. The phone domain name service 108 may access the database 110 from a private URL/URI or a public URL/URI, either of which may be a source independent of the phone domain name service 108. For example, the phone domain name service 108 may access the database 110 for the NETFLIX.CALL phone domain name from HTTP://WWW.NETFLIX.COM. Alternatively, the phone domain name service 108 may access the database 110 for the GONAZLESFAMILYNM.COM phone domain name from HTTP://WWW.GFNM.ORG. Additionally, the phone domain name service 108 may access the database 110 for the DELL.PH phone domain name from HTTP://WWW.DELL.COM/PHONE DOMAINDB.

At operation 606, the accessing a database for the phone domain name at 206 may include accessing the database using a definable relationship between the phone domain name and the source independent of the phone domain name service. In some embodiments, the phone domain name service 108 accesses the database 110 using a definable relationship between the phone domain name and the source independent of the phone domain name service 108. The definable relationship may include a default relationship, an automatically determined relationship, or a specified relationship between the phone domain name and the source independent of the phone domain name service 108. The default relationship may be an internet domain name coinciding with a phone domain name, such as WWW.YAHOO.COM for YAHOO.PHN or WWW.IBM.COM for IBM.CALL. Alternatively, the automatically determined relationship may be a URL/URI determined by a web crawler, bot, or other similar technology.

At operation 608, the accessing a database for the phone domain name at 206 may include accessing the database being for two or more phone domain names. In some embodiments, the phone domain name service 108 accesses the database 110 being for two or more phone domain names. The database 110 may include phone names corresponding to phone numbers for two or more phone domain names. For example, the database 110 may include phone names corresponding to phone numbers for the GOOGLE.COM phone domain name, the WEBERCONSULTINGGROUP phone domain name, and the JOHNSONSINPORTLAND.FON phone domain name. However, the phone names corresponding to phone numbers may be filterable or selectable in view of a specified phone domain name. In certain embodiments, the database 110 is distributed across a plurality of databases and/or computers.

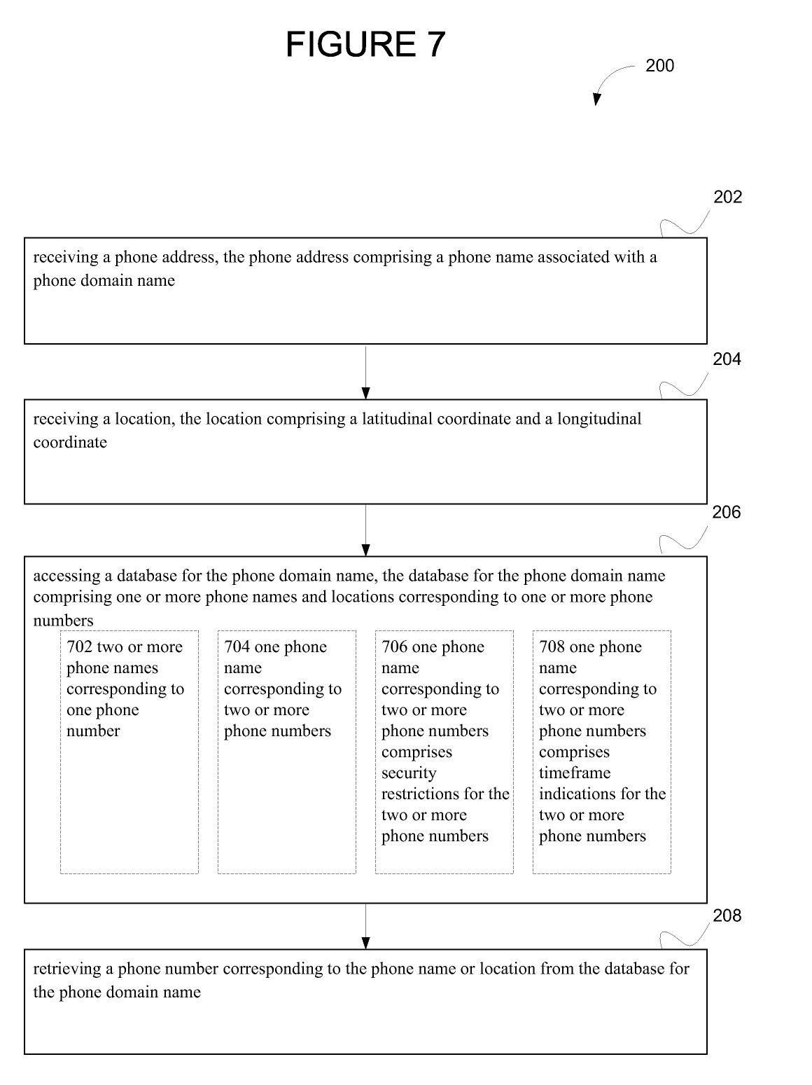

FIG. 7 is a flow diagram including various embodiments of a method performed by a software application of a phone domain name service, in accordance with various embodiments of the invention. Method 200 may include one or more operations including operation 702, 704, 706, and/or 708.

At operation 702, the accessing a database for the phone domain name at 206 may include the database having two or more phone names corresponding to one phone number. In some embodiments, the database 110 for the phone domain name at least comprises two or more phone names corresponding to one phone number. The two or more phone names corresponding to one phone number may include various aliases corresponding to one phone number. For example, the phone names DAVID, DAVIDJ, DAVIDJACKSON, DJ, DJACKSON, and JACKSON may all correspond to one phone number within the database 110 for the JACKSONFAMILY.PHO phone domain name. Alternatively, the phone names RECEPTION, SALLY, SALLYWILBUR, WILBUR, SW, FRONTDESK, and SUPPORT may all correspond to one phone number within the database 110 for the HANKSAUTOMOTIVE.CALL phone domain name.

At operation 704, the accessing a database for the phone domain name at 206 may include the database having one phone name corresponding to two or more phone numbers. In some embodiments, the database 110 for the phone domain name has one phone name corresponding to two or more phone numbers. The one phone name corresponding to two or more phone numbers may include one phone name corresponding to a plurality of alternative phone numbers. For example, the phone name DAVID may correspond to a home phone number, an office phone number, a mobile phone number, and a vacation home phone number within the database 110 for the JACKSONFAMILY.PHO phone domain name. Alternatively, the phone name SALLY may correspond to a front desk phone number, an office kitchen phone number, a conference room phone number, and a mobile phone number within the database 110 for the HANKSAUTOMOTIVE.CALL phone domain name.

At operation 706, the accessing a database for the phone domain name at 206 may include the database having one phone name corresponding to two or more phone numbers comprising security restrictions for the two or more phone numbers. In some embodiments, the database 110 for the phone domain name has one phone name corresponding to two or more phone numbers comprising security restrictions for the two or more phone numbers. The security restrictions for the two or more phone numbers may include restrictions on the release of any of the two or more phone numbers, such as password restrictions or requesting source identity restrictions. For example, the phone name DAVID may correspond to a home phone number, an office phone number, a mobile phone number, and a vacation home phone number within the database 110 for the JACKSONFAMILY.PHO phone domain name with the mobile phone number and the vacation home phone number having password security restrictions. In certain embodiments, the password may be supplied within the phone address, such as DAVID:[PASSWORD] [symbol] JACKSONFAMILY.PHO. Alternatively, the phone name SALLY may correspond to a front desk phone number, an office kitchen phone number, a conference room phone number, and a mobile phone number within the database 110 for the HANKSAUTOMOTIVE.CALL phone domain name with the mobile phone number having a requesting source restriction. In certain embodiments, the requesting source may be identified by callerID or within the phone address such as [IDENTITY OF REQUESTING SOURCE]: SALLY [symbol] HANKSAUTOMOTIVE.CALL. In other embodiments, the database 110 for the phone domain name has phone names corresponding to phone numbers, any of which may have security restrictions such as those referenced herein.

At operation 708, the accessing a database for the phone domain name at 206 may include the database having one phone name corresponding to two or more phone numbers comprising timeframe indications for the two or more phone numbers. In some embodiments, the database 110 for the phone domain name has one phone name corresponding to two or more phone numbers comprising timeframe indications for the two or more phone numbers. The timeframe indications for the two or more phone numbers may include indications on the release of any of the two or more phone numbers, such as blackout period indications whereby a phone number is unavailable. For example, the phone name DAVID may correspond to a home phone number, an office phone number, a mobile phone number, and a vacation home phone number within the database 110 for the JACKSONFAMILY.PHO phone domain name with the mobile phone number having blackout period indications for after 6 pm PST Monday through Saturday and all day Sunday. In certain embodiments, a password may be supplied to overcome any timeframe indications. Alternatively, the phone name SALLY may correspond to a front desk phone number, an office kitchen phone number, a conference room phone number, and a mobile phone number within the database 110 for the HANKSAUTOMOTIVE.CALL phone domain name with the mobile phone number having blackout period indications for after 5 pm PST Monday through Friday and all day Saturday and Sunday. In other embodiments, the database 110 for the phone domain name has phone names corresponding to phone numbers, any of which may have timeframe indications such as those referenced herein.

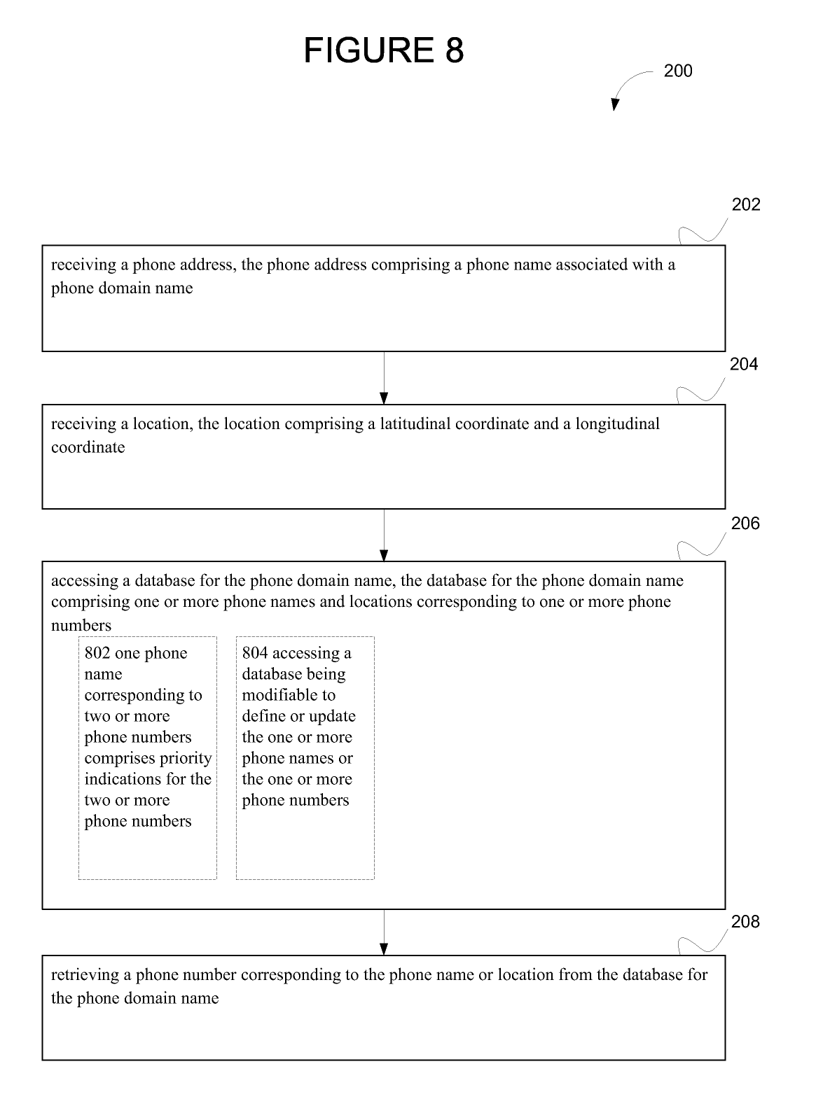

FIG. 8 is a flow diagram including various embodiments of a method performed by a software application of a phone domain name service, in accordance with various embodiments of the invention. Method 200 may include one or more operations including operation 802 and/or 804.

At operation 802, the accessing a database for the phone domain name at 206 may include the database having one phone name corresponding to two or more phone numbers comprising priority indications for the two or more phone numbers. In some embodiments, the database 110 for the phone domain name has one phone name corresponding to two or more phone numbers comprising priority indications for the two or more phone numbers. The priority indications for the two or more phone numbers may include indications on the priority of the two or more phone numbers, such as the priority for using the two or more phone numbers when attempting to establish a telephone call. For example, the phone name DAVID may correspond to a home phone number, an office phone number, a mobile phone number, and a vacation home phone number within the database 110 for the JACKSONFAMILY.PHO phone domain name with priority indications for using the phone numbers in the following order when attempting to establish a telephone call: mobile phone number, office phone number, home phone number, and vacation home phone number. Alternatively, the phone name SALLY may correspond to a front desk phone number, an office kitchen phone number, a conference room phone number, and a mobile phone number within the database 110 for the HANKSAUTOMOTIVE.CALL phone domain name with priority indications for using the phone numbers in the following order when attempting to establish a telephone call: front desk phone number, conference room phone number, office kitchen phone number, and mobile phone number. In certain embodiments, timeframe indications may alter the priority indications depending upon a time of day.

At operation 804, the accessing a database for the phone domain name at 206 may include accessing a database being modifiable to define or update the one or more phone names or the one or more phone numbers. In some embodiments, the phone domain name service 108 accesses the database 110 being modifiable to define or update the one or more phone names or the one or more phone numbers. The database 110 may be modifiable to add a phone name or phone number, remove a phone name or phone number, change a phone name or phone number, organize phone names and phone numbers, manage timeframe indications, manage security restrictions, manage priority indications, or any other similar operation. The database 110 may be modifiable directly or through a user interface, such as a website or client application. The database 110 may be modifiable automatically by accessing an alternative data source such as a contact manager program, a contact information website, or a social networking website such as FACEBOOK or LINKEDIN. For example, the database 110 for the FRIENDSOFHARRY.PHO phone domain name may include a phone name and phone number for BRAD, JOHN, and PHILLIP. The database 110 for the FRIENDSOFHARRY.PHO may be modifiable to add a new friend phone name and phone number, remove a friend phone name and phone number, or update a friend phone name and phone number automatically based upon changes to a network of friends on a social networking site or based upon updates of any friend's profiles on a social networking site.

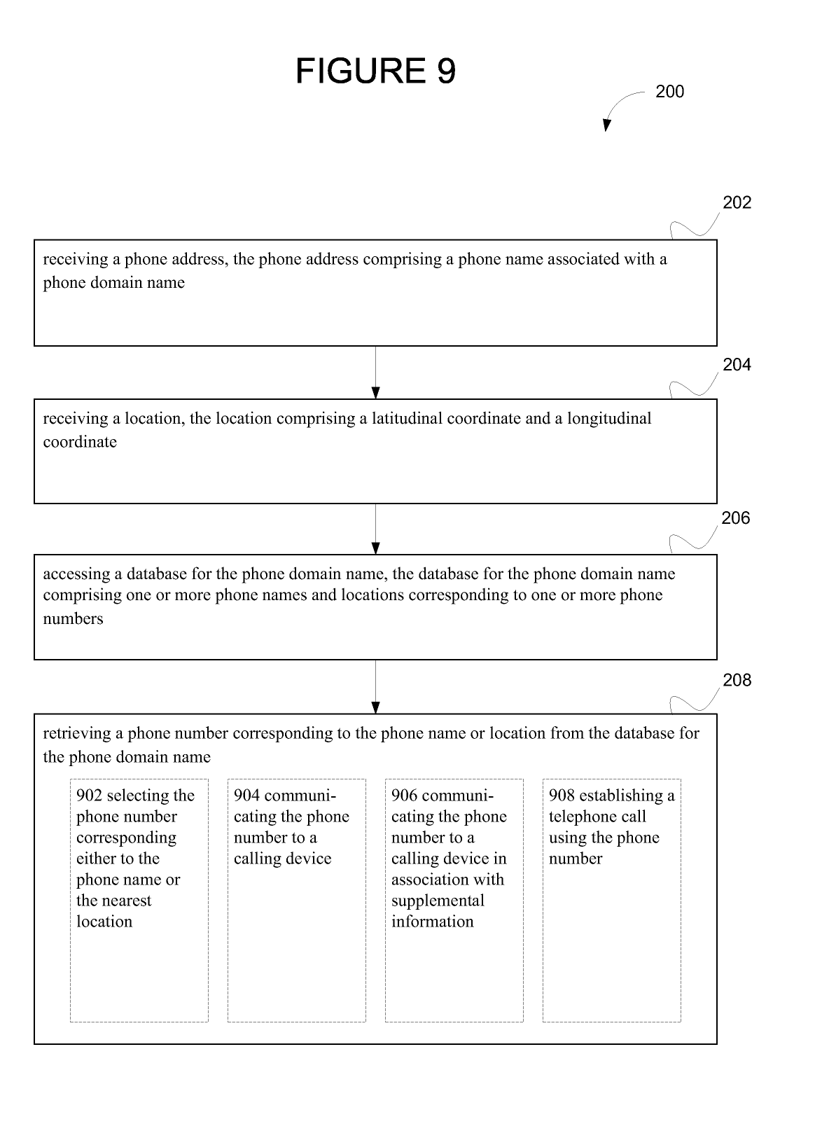

FIG. 9 is a flow diagram including various embodiments of a method performed by a software application of a phone domain name service, in accordance with various embodiments of the invention. Method 200 may include one or more operations including operation 902, 904, 906 and/or 908.

At operation 902, the retrieving a phone number corresponding to the phone name or location from the database for the phone domain name may include selecting the phone number corresponding either to the phone name or the nearest location. In some embodiments, the phone domain service 108 communicates the phone number to the calling device 102. The phone domain name service 108 may select the phone number from the phone domain name database 110 using either the phone name or the location provided by the calling device 102. The phone domain service 108 may contain software which determines which selection criteria to use. For example, the phone domain service 108 may provide the phone number corresponding to the nearest location when the phone name specified is LOC. In some embodiments, the phone domain service 108 selects the phone number using the phone name, but provides an option, when available, for selecting nearer phone number using the location.

At operation 904, the retrieving a phone number corresponding to the phone name or location from the database for the phone domain name may include communicating the phone number to a calling device. In some embodiments, the phone domain name service 108 communicates the phone number to the calling device 102. The phone domain name service 108 may communicate the phone number to the calling device 102 via spoken language, via a text message, via a browser response, via a data packet, via a data stream, or any other similar methodology. The calling device 102 may then store the phone number, communicate the phone number, initiate a telephone call using the phone number, or any other similar operation.

At operation 906, the retrieving a phone number corresponding to the phone name or location from the database for the phone domain name may include communicating the phone number to a calling device in association with supplemental information. In some embodiments, the phone domain name service 108 communicates the phone number to the calling device 102 in association with supplemental information. The phone domain name service 108 may communicate the supplemental information to the calling device before, while, or after communicating the phone number. The supplemental information can include additional contact information, such as a mailing address, a website address, an email address, alternative phone numbers, contact names, or other similar information, or can include other non-contact information such as a website, a menu, hours of operation, directions, pictures, sound, images, videos, documents, files, or the like, all of which can be related to the phone number.

At operation 908, the retrieving a phone number corresponding to the phone name or location from the database for the phone domain name may include establishing a telephone call using the phone number. In some embodiments, the phone domain name service 108 establishes a telephone call using the phone number. The phone domain name service 108 may establish a telephone call with the phone number using the phone company 104. In some embodiments, the phone company 104 establishes a telephone call using the phone number. For example, the calling device 102 may communicate a phone address to the phone domain name service 108 and the phone domain name service 108 may complete the telephone call by establishing a connection with the receiving device 106 using the phone number determined from the phone address. Alternatively, the calling device 102 may communicate a phone address to the phone company 104 and the phone company 104 may complete the telephone call by establishing a connection with the receiving device 106 using the phone number determined from the phone address using the phone domain name service 108. Also, the calling device 102 may communicate a phone address to the phone domain name service 108 and the phone domain name service 108 may complete the telephone call by calling the calling device 102 and the receiving device 106 using the phone number determined from the phone address.

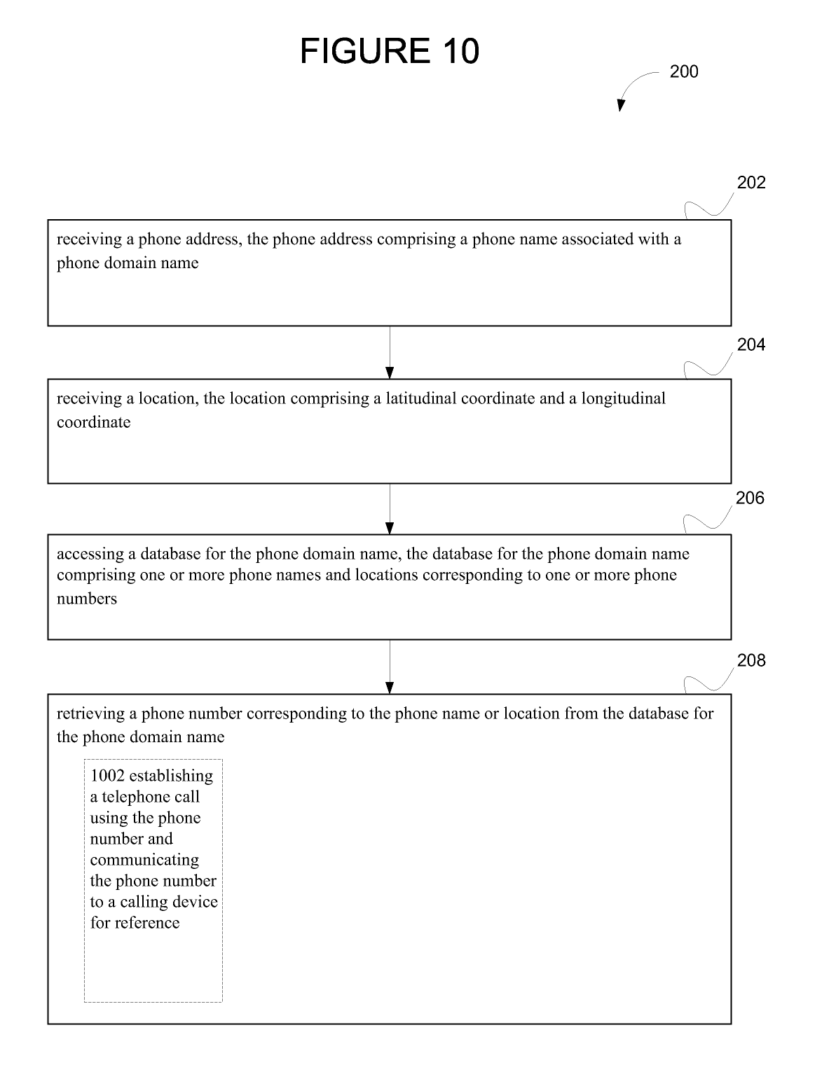

FIG. 10 is a flow diagram including various embodiments of a method performed by a software application of a phone domain name service, in accordance with various embodiments of the invention. Method 200 may include one or more operations including operation 1002.

At operation 1002, the retrieving a phone number corresponding to the phone name or location from the database for the phone domain name may include establishing a telephone call using the phone number and communicating the phone number to a calling device for reference. In some embodiments, the phone domain name service 108 communicates the phone number to a calling device for reference. In some embodiments, the phone company 104 communicates the phone number to a calling device for reference. For example, the calling device 102 may communicate a phone address to the phone domain name service 108 and the phone domain name service 108 may complete the telephone call by establishing a connection with the receiving device 106 using the phone number determined from the phone address and may communicate the phone number to the calling device 102. Alternatively, the calling device 102 may communicate a phone address to the phone company 104 and the phone company 104 may complete the telephone call by establishing a connection with the receiving device 106 using the phone number determined from the phone address using the phone domain name service 108 and may communicate the phone number to the calling device 102. Also, the calling device 102 may communicate a phone address to the phone domain name service 108 and the phone domain name service 108 may complete the telephone call by calling the calling device 102 and the receiving device 106 using the phone number determined from the phone address and may communicate the phone number to the calling device 102.

In some embodiments, the phone domain name service 108 is configured to performing reverse lookups of phone addresses using a received phone number, such as for informational purposes or for callerID purposes.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A phone domain name service configured to performing the operations comprising:
receiving a phone address, the phone address comprising a phone name associated with a phone domain name;
receiving a location, the location comprising a latitudinal coordinate and a longitudinal coordinate;
accessing a database for the phone domain name, the database for the phone domain name comprising one or more phone names and locations corresponding to one or more phone numbers; and
retrieving a phone number corresponding to the phone name or location from the database for the phone domain name.

2. The phone domain name service of claim 1, wherein the receiving a phone address comprises receiving the phone address from a calling device.

3. The phone domain name service of claim 2, wherein the receiving the phone address from a calling device comprises receiving the phone address from the calling device as a DTMF translation of the phone address.

4. The phone domain name service of claim 2, wherein the receiving the phone address from a calling device comprises receiving the phone address from the calling device via a telephone call, a text message, an instant message, a data packet, or a data stream.

5. The phone domain name service of claim 1, wherein the receiving a phone address comprises receiving the phone address via a user interface selection.

6. The phone domain name service of claim 1, wherein the receiving a phone address comprises receiving the phone address from a phone company.

7. The phone domain name service of claim 1, wherein the receiving a location comprises receiving the location from a calling device.

8. The phone domain name service of claim 7, wherein the receiving the location from a calling device comprises receiving the location from a GPS program on the calling device.

9. The phone domain name service of claim 1, wherein the accessing a database for the phone domain name comprises accessing the database from a source independent of the phone domain name service.

10. The phone domain name service of claim 9, wherein the accessing the database from a source independent of the phone domain name service comprises accessing the database from a URL.

11. The phone domain name service of claim 9, wherein the accessing the database from a source independent of the phone domain name service comprises accessing the database using a definable relationship between the phone domain name and the source independent of the phone domain name service.

12. The phone domain name service of claim 1, wherein the accessing a database for the phone domain name comprises accessing the database being for two or more phone domain names.

13. The phone domain name service of claim 1, wherein the one or more phone names and locations corresponding to one or more phone numbers at least comprises two or more phone names corresponding to one phone number.

14. The phone domain name service of claim 1, wherein the one or more phone names and locations corresponding to one or more phone numbers at least comprises one phone name corresponding to two or more phone numbers.

15. The phone domain name service of claim 14, wherein the one phone name corresponding to two or more phone numbers comprises security restrictions for the two or more phone numbers.

16. The phone domain name service of claim 14, wherein the one phone name corresponding to two or more phone numbers comprises timeframe indications for the two or more phone numbers.

17. The phone domain name service of claim 14, wherein the one phone name corresponding to two or more phone numbers comprises priority indications for the two or more phone numbers.

18. The phone domain name service of claim 1, wherein the accessing a database for the phone domain name comprises accessing a database being modifiable to define or update the one or more phone names or the one or more phone numbers.

19. The phone domain name service of claim 1, wherein the retrieving a phone number corresponding to the phone name or location from the database for the phone domain name comprises selecting the phone number corresponding either to the phone name or the nearest location.

20. The phone domain name service of claim 1, wherein the retrieving a phone number corresponding to the phone name or location from the database for the phone domain name comprises communicating the phone number to a calling device.
